(19) United States
(12) Patent Application Publication
(10) Pub. No.: US 2011/0088653 A1
(43) Pub. Date: Apr. 21, 2011

(54) Backwards Injected Engine

(76) Inventor: Francis X. Gentile, Los Angeles, CA (US)

(21) Appl. No.: 12/758,873

(22) Filed: Apr. 13, 2010

Related U.S. Application Data
(60) Provisional application No. 61/168,625, filed on Apr. 13, 2009.

(51) Int. Cl. F02B 3/00

(52) U.S. Cl. 123/298

(57) ABSTRACT

Fuel is injected into and through the exhaust port and into the cylinder of the piston engine during the time when the flow is reversed from the normally expected flow. The engine is able to operate with some or all of its fuel injected backwards of conventional expectations. In another embodiment the fuel is injected with solid stream injector sprays directed against exhaust valves and ports and deflected into the piston cylinder against the flow of normally aspirated or supercharged engines. This invention can apply to gasoline or diesel cycles and four and two stroke type cycles of engine.

### BRIEF DESCRIPTION OF THE SEVERAL VIEW OF THE DRAWINGS

### Drawings—Figures

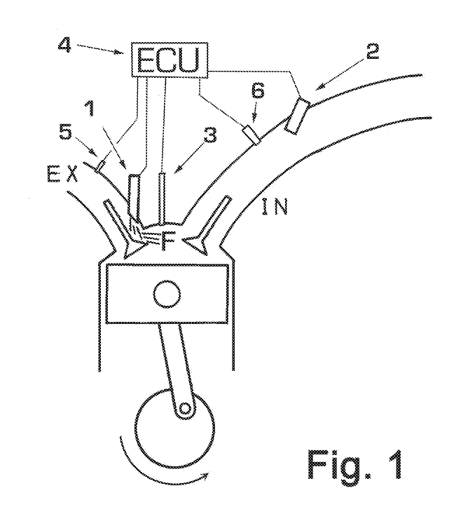

FIG. 1 Shows a System Schematic.

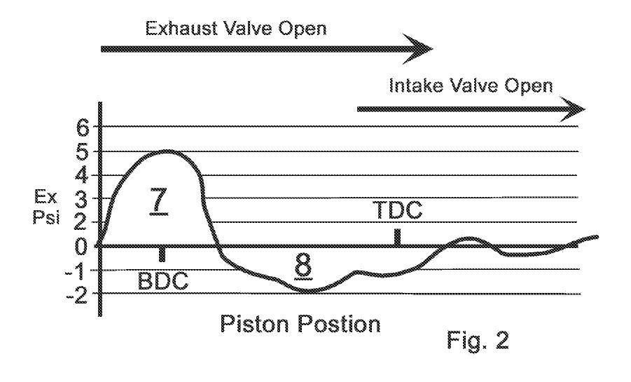

FIG. 2 Shows An example exhaust tract pressure map for a four stroke poppet valve engine is shown as an example in graph FIG. 2.

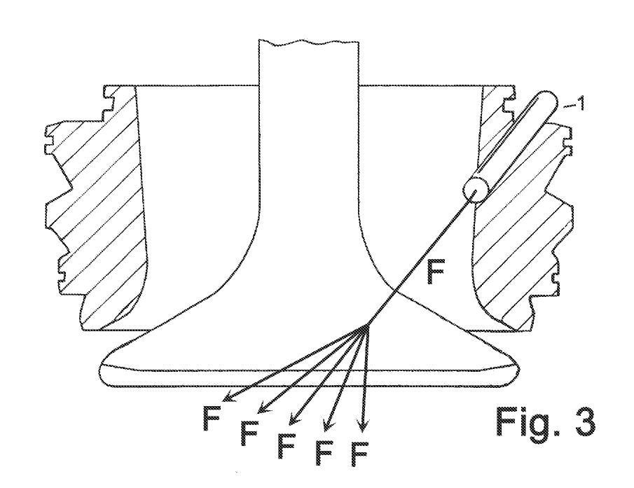

FIG. 3 Shows an embodiment of deflecting solid streams of fuel (F) (or water) onto the exhaust valves.

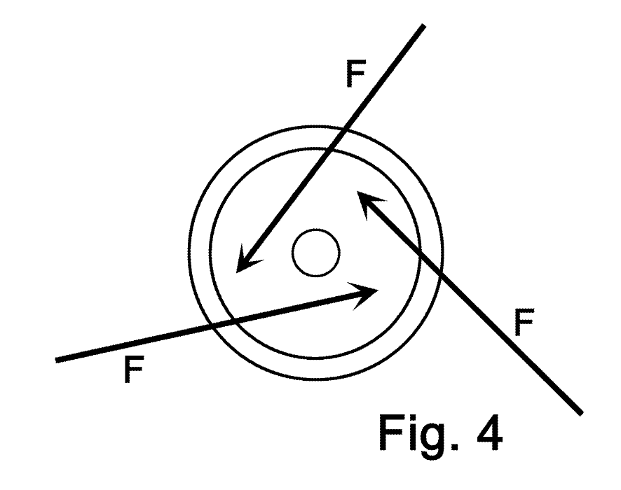

FIG. 4 Shows a view of an exhaust poppet valve from above showing an embodiment with three solid stream fuel (F) injection streams deflected off of evenly distributed points of the valve.

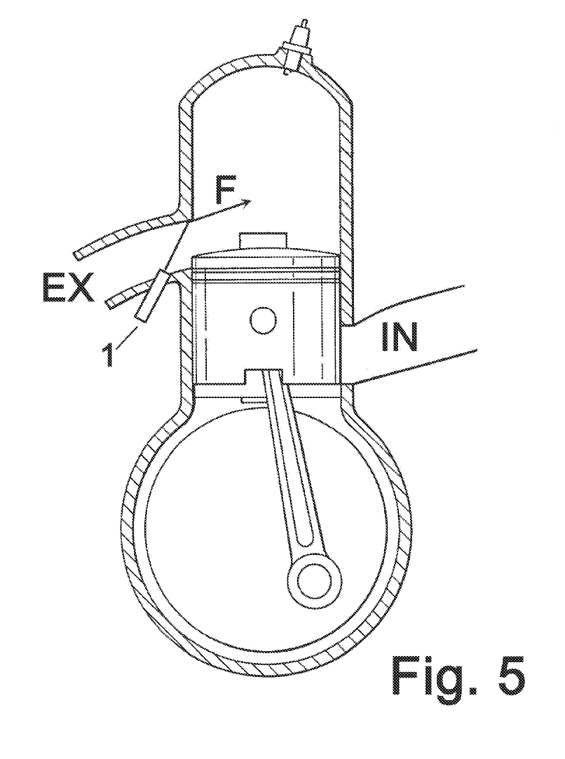

FIG. 5 illustrates an embodiment of one or more solid stream or non-atomizing fuel injector's 1 injections are deflected against the exhaust tract edge of a piston operated cylinder exhaust valve port and said stream (F) is deflected into said combustion chamber and or cylinder of a two stroke engine.

In one embodiment a piston in an internal combustion engine is pushed down to the bottom of the cylinder which causes the opening of exhaust ports. The pressure in the exhaust piping is positive 7 (FIG. 2) after combustion. The pressure is released in a wave out the exhaust system. After the positive pressure wave comes a negative pressure wave 8 (FIG. 2) which is the indication of flow known to be capable of bringing exhaust gases back thru the combustion chamber and as far as the intake tract (IN) (FIG. 1). An example exhaust tract pressure map for a four stroke poppet valve engine is shown as an example in graph FIG. 2. In practice the shape of the graph may be difficult to predict and depends on the engine configuration and operating conditions. The waves of energy are sometimes described as caused by the subsonic organ pipe effect of the end of the pipe causing the reflection backwards to its origin based on the length of the pipe. The reflections have also been described by the supersonic shock waves which can emanate from the pressure release of the opening of the exhaust valve and also reflect backwards from the end of the exhaust tube towards the origin at the exhaust valve.

Pressure in the Exhaust tract is an indirect indication of the direction of flow with in the exhaust tract, positive is flow outward from the cylinder and negative pressure into the cylinder which can be cross verified by intake pressure, crankshaft or camshaft position, cylinder pressure. In one embodiment pressure sensors in the exhaust tract 5 (FIG. 1), combustion chamber 3 (FIG. 1), intake tract 6 (FIG. 1) send condition information to the Engine Control Unit (ECU) 4 (FIG. 1). The ECU triggers fuel injectors in the exhaust port 1 (FIG. 1). The ECU can also trigger fuel injector 2 (FIG. 1) on the conventional intake side when conditions are desirable or necessary such as when the engine is cold and starting. For simplicity the other sensors commonly used on fuel injections are not shown in the diagram, but would or could be used, for example, oxygen sensor, knock sensor, air mass sensor, intake temperature, cylinder head temperature, exhaust gas temperature.

Another embodiment of this invention utilizes variations in the fuel delivered from the intake and the exhaust ports to achieve variation in fuel to air ratios that allow ignition while also allowing complete burning without high combustion temperatures which lead to nitrogen oxide formation.

Another embodiment of this invention utilizes different fuels in the intake versus the exhaust to better achieve the results described in the paragraph above.

In FIG. 3 show An embodiment of deflecting solid streams of fuel (F) (or water) onto the exhaust valves to create atomization of fuel, entry of fuel into the combustion chamber against or with the gas flow, cooling of the valve central body.

As velocity decreases over distance more rapidly as droplets form and become smaller, a solid stream therefore maintains the maximum velocity against turbulence and opposite gas flow and therefore is able to oppose and traverse the exhaust gas flow. The impact of the solid stream on the poppet valve produces different liquid sheet angles and the break-up lengths at various angles and locations of impact on different shapes of valves.

Restated, Solid stream nozzles provide the highest impact per unit area. The large free passage design through the typically round solid stream nozzle orifice reduces clogging. In one embodiment a solid stream non-atomized spray directed against the exhaust valve achieves fuel heating and atomization from the deflection impact against the valve and the fuel charge flow against the flow of exhaust gases.

More than one injector can be used to create even thermal conditions in the valve metal which would reduce internal stresses within the metal because of differences in thermal expansion and contraction. FIG. 4 is a view of a exhaust poppet valve from above showing an embodiment with three solid stream fuel (F) injection streams deflected off of evenly distributed points of the valve.

The location of highest heat in the valve are presented in U.S. Pat. No. 4,073,474. Heat in the poppet valve periphery that contacts the valve seat is conducted away from the poppet valve. The hot center of the valve disk or head expands the metal against the cooler less thermally expended valve head periphery in contact with the valve seat, resulting in hoop stress and cracks within the valve periphery that contacts the valve seat within the intake tract. In one embodiment of this invention cooling from fuel and or water spray would be best directed upon this hot center of the valve head. Described in alternate language, the solid spray impacts between the beginning of the poppet valve stem and the beginning of the part of the valve periphery which makes contact with the valve seat in the cylinder head.

Fortunately the exhaust valve is typically placed in the cylinder head with a short exit path to the exhaust header, so it maybe possible to perform conversions of existing engines by installing injectors in the exhaust headers. Smaller injectors know as pico injectors are available. Smaller single cylinder engines or engines with separated cylinders allow more direct access to the exhaust valve from many directions and thus are better candidates for inexpensive conversion.

Small two stroke engines present a simpler conversion. FIG. 5 illustrates embodiment of one or more solid stream or non-atomizing fuel injector's 1 injections are deflected against the exhaust tract edge of a piston operated cylinder exhaust valve port and said stream (F) is deflected into said combustion chamber and or cylinder of a two stroke engine.

What is claimed is:

1. A naturally aspirated internal combustion piston engine with separate intake and exhaust valves and or piping having fuel introduced into the combustion chamber and cylinder for the next cycle of combustion thru said exhaust valve or piping of said combustion chamber or cylinder during the moments when the exhaust flow is backwards during the exhaust cycle while the exhaust system is open to said combustion chamber and or cylinder thru the exhaust valve.

2. The engine of claim 1 wherein one or more solid stream or non-atomizing fuel injector's injections are deflected against the area of an exhaust poppet valve that exists between the stem of the valve and the part of the valve which touches the valve seat when closed, and said stream is deflected into said combustion chamber and or cylinder.

3. The engine of claim 1 wherein one or more solid stream or non-atomizing fuel injector's injections are deflected against the area of an exhaust poppet valve that touches the exhaust poppet valve seat when closed, and said stream is deflected into said combustion chamber and or cylinder.

4. The engine of claim 1 wherein one or more solid stream or non-atomizing fuel injectors inject through the gap between the exhaust poppet valve and the valve seat and said stream enters undeflected into said combustion chamber and or cylinder.

5. The engine of claim 1 wherein an atomizing fuel injector injects fuel towards said exhaust valve.

6. The engine of claim 1 wherein one or more solid stream or non-atomizing fuel injector's injections are deflected against the exhaust tract edge of a piston operated cylinder exhaust valve port and said stream is deflected into said combustion chamber and or cylinder.

7. The engine of claim 1 wherein one or more solid stream or non-atomizing fuel injectors inject through an open piston operated cylinder exhaust valve port into said combustion chamber and or cylinder.

8. A supercharged or naturally aspirated internal combustion piston engine with separate intake and exhaust valves and or piping having fuel introduced into the combustion chamber and cylinder for the next cycle of combustion thru said exhaust valve or piping of said combustion chamber or cylinder during the moments of the exhaust cycle while the exhaust system is open to said combustion chamber and or cylinder thru the exhaust valve.

9. The engine of claim 8 wherein one or more solid stream or non-atomizing fuel injector's injections are deflected against the area of an exhaust poppet valve that exists between the stem of the valve and the part of the valve which touches the valve seat when closed, and said stream is deflected into said combustion chamber and or cylinder.

10. The engine of claim 8 wherein one or more solid stream or non-atomizing fuel injector's injections are deflected against the area of an exhaust poppet valve that touches the exhaust poppet valve seat when closed, and said stream is deflected into said combustion chamber and or cylinder.

11. The engine of claim 8 wherein one or more solid stream or non-atomizing fuel injectors inject through the gap between the exhaust poppet valve and the valve seat and said stream enters undeflected into said combustion chamber and or cylinder.

12. The engine of claim 8 wherein an atomizing fuel injector injects fuel towards said exhaust valve.

13. The engine of claim 8 wherein one or more solid stream or non-atomizing fuel injector's injections are deflected against the exhaust tract edge of a piston operated cylinder exhaust valve port and said stream is deflected into said combustion chamber and or cylinder.

14. The engine of claim 8 wherein one or more solid stream or non-atomizing fuel injectors inject through an open piston operated cylinder exhaust valve port into said combustion chamber and or cylinder.

15. A supercharged or naturally aspirated internal combustion piston engine with separate intake and exhaust valves and or piping with a means for simultaneously cooling the exhaust valves and heating the fuel mixture by injecting fuel through the exhaust tract into the combustion chamber of an internal combustion engine during the exhaust cycle.

16. A method of deflecting a solid stream of fuel off of parts of exhaust valve or port areas to direct and atomize the fuel into the combustion chamber or cylinder while overcoming hot gas flow in the opposite direction without burning or explosion.

16. A method of timing the injection into the exhaust tract by measuring the exhaust tract pressure to estimate the direction of flow to inject with the flow back into the combustion chamber or cylinder.
